(19) United States
(12) Patent Application Publication
(10) Pub. No.: US 2016/0116904 A1
(43) Pub. Date: Apr. 28, 2016

(54) Mobile 3-D Service Part Printing

(71) Applicant: Caterpillar Inc., Peoria, IL (US)

(72) Inventors: Jeffrey Edward Jensen, Dunlap, IL (US); Viral S. Mehta, Peoria, IL (US)

(73) Assignee: Caterpillar Inc., Peoria, IL (US)

(21) Appl. No.: 14/522,341

(22) Filed: Oct. 23, 2014

(51) Int. Cl. G05B 19/4099

(52) U.S. Cl. CPC G05B 19/4099; G05B 2219/49023

(57) ABSTRACT

A method for mobile three-dimensional (3-D) printing of a component of a machine is disclosed. The method includes determining a distance between a transport and a customer based on, at least, positioning information provided by a positioning system. The method further includes determining a route for the transport to travel to the customer based on, at least, the distance between the transport and the customer. The method further includes printing, at least in part, the component of the machine using a 3-D printer while the transport travels along the route, the 3-D printer being associated with the transport and travelling with the transport along the route.

### TECHNICAL FIELD OF THE DISCLOSURE

The present disclosure generally relates to providing, by a dealer, machine parts to a customer and, more particularly, relates to systems and methods for mobile three-dimensional (3-D) printing of machine components.

### BACKGROUND OF THE DISCLOSURE

Machines typically include a variety of specific component parts made specifically for that machine or for a group of related machines. Over time, these component parts may need replacement. As the machines may require specific parts (e.g., a specific bracket for a specific model of tractor), owners of said machines may receive replacement parts from the dealer of the machine. Thusly, the machine-owner must either travel to a dealer location or have the part delivered from the dealer. Either way, due to fuel costs and other expense factors associated with delivery and/or customer travel, customers and dealers seek to provide the path of least resistance from the customer to his/her replacement part. Additionally, when using such machines, the time spent without said machine creates a burden on the customer. Therefore, it is in the best interests of both the customer and the dealer to provide replacement parts to the customer in a quick and cost-effective manner.

Many well-known logistics methods exist for delivery by dealers and/or delivery personnel associated with the dealers, which aim to improve upon delivery speed and cost effectiveness. For example, most dealers who provide machines to customers will keep inventory of what parts they have at each dealer location. Therefore, the dealer can effectively access the inventory to determine what locations have the replacement part, which the customer needs, in stock. Then, the dealer can determine the closest dealer location that has the replacement part in stock and subsequently ship the part from that location.

However, some parts requested by a customer may be carried in low quantity by the dealer, may be rare, and/or may not be produced often. In such cases, the shipment of the parts may be burdensome to the dealer and the customer. For example, if a customer in Rochester, New York requests a replacement part from a dealer and the dealer's inventory shows that the only available replacement part exists at a warehouse in San Diego, California, the shipping from San Diego to Rochester may prove burdensome to one or both parties.

Further, in attempts to make such parts available in more locations, dealers have experimented with methods of three-dimensional (3-D) printing of machine parts. 3-D printers can receive a digital file containing specifications for a component part and generate the part by printing the component using a wide array of different materials. Therefore, a part producer can transmit a specification for a component part to a remote location for manufacture. For example, such methods are described in International Application WO2012071449 (“Architectures, methods, and systems for remote manufacturing of earth-penetrating tools”), wherein a manufacturer of rock bits transmits bit designs to a manufacturing site for additive manufacturing.

However, such methods will still present similar time and cost issues if the manufacturing site is far from the customer. Therefore, for optimizing wait time and cost for both the customer and the dealer, systems and methods for mobile 3-D printing of machine components are desired.

### SUMMARY OF THE DISCLOSURE

In accordance with one aspect of the present disclosure, a method for mobile three-dimensional (3-D) printing of a component of a machine is provided. The method may include determining a distance between a transport and a customer based on, at least, positioning information provided by a positioning system. The method may further include determining a route for the transport to travel to the customer based on, at least, the distance between the transport and the customer. The method may further include printing, at least in part, the component of the machine using a 3-D printer while the transport travels along the route, the 3-D printer being associated with the transport and travelling with the transport along the route.

In accordance with another aspect of the disclosure, a system for mobile 3-D printing of a component of a machine is provided. The system may include a transport for delivering the component to a customer and a positioning system for providing position information associated with a location of the customer. The system may further include a controller configured to receive the positioning information from the positioning system, determine a distance between the transport and the customer using the positioning information, and determine a route for the transport to travel to the customer. The system may further include a 3-D printer associated with the transport, configured to travel with the transport along the route and configured to print the component while travelling along the route.

In accordance with yet another aspect of the disclosure, a method for providing a component of a machine to a customer by optionally utilizing 3-D printing of the component is provided. The method may include receiving an order for the component from the customer, the customer at a customer location, and determining availability of a manufactured component at a part storage location. The method may further include determining a first transportation route if the manufactured component is available at the part storage location, the first transportation route being between the customer location and the part storage location. The method may further include determining a second transportation route, the second transportation route being between the customer location and a printing transport, the printing transport being associated with a 3-D printer and capable of travelling with the 3-D printer, the 3-D printer capable of printing a printed component for use as the component. The method may further include determining if the printing transport travelling along the second route will arrive at the customer location at an earlier time than a transport travelling along the first route. The method may further include printing, at least in part, the printed component using the 3-D printer while the printing transport travels along the second route if the printing transport travelling along the second route will arrive at the customer location at an earlier time than the transport travelling along the first route. In some examples, the method may further include delivering the manufactured component from the part storage location using the transport travelling along the first route if the transport travelling along the first route will arrive at the customer location at an earlier time than the printing transport travelling along the second route.

Other features and advantages of the disclosed systems and principles will become apparent from reading the following detailed disclosure in conjunction with the included drawing figures.

### BRIEF DESCRIPTION OF THE DRAWINGS

FIG. 1 is a schematic diagram of an example system for mobile 3-D printing in accordance with the present disclosure.

FIG. 2 is a schematic diagram of an example transport for mobile 3-D printing in association with the system of FIG. 1 and in accordance with the present disclosure.

FIG. 3 is a schematic diagram depicting example dealer and customer locations in association with the systems and methods of the present disclosure.

FIG. 4 is a schematic diagram for an example computer that may execute instructions for providing the example systems and methods of the present disclosure.

FIG. 5 is an example flowchart for a method for mobile 3-D printing in accordance with the present disclosure.

FIG. 6 is an example flowchart for a method for providing a component of a machine to a customer by optionally utilizing 3-D printing of the component in accordance with the present disclosure.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto.

### DETAILED DESCRIPTION OF THE DISCLOSURE

The present disclosure provides systems and methods for mobile three-dimensional (3-D) printing of a component of a machine. Such systems and methods involve the manufacture, at least in part, and concurrent transport of components of the machine from a dealer location to the customer. The machine may be any machinery which involves component parts that may be manufactured using 3-D printing methods. Example machines for which such components may be needed include, but are not limited to including, tractors, loaders, mining trucks, graders, and any other heavy machinery.

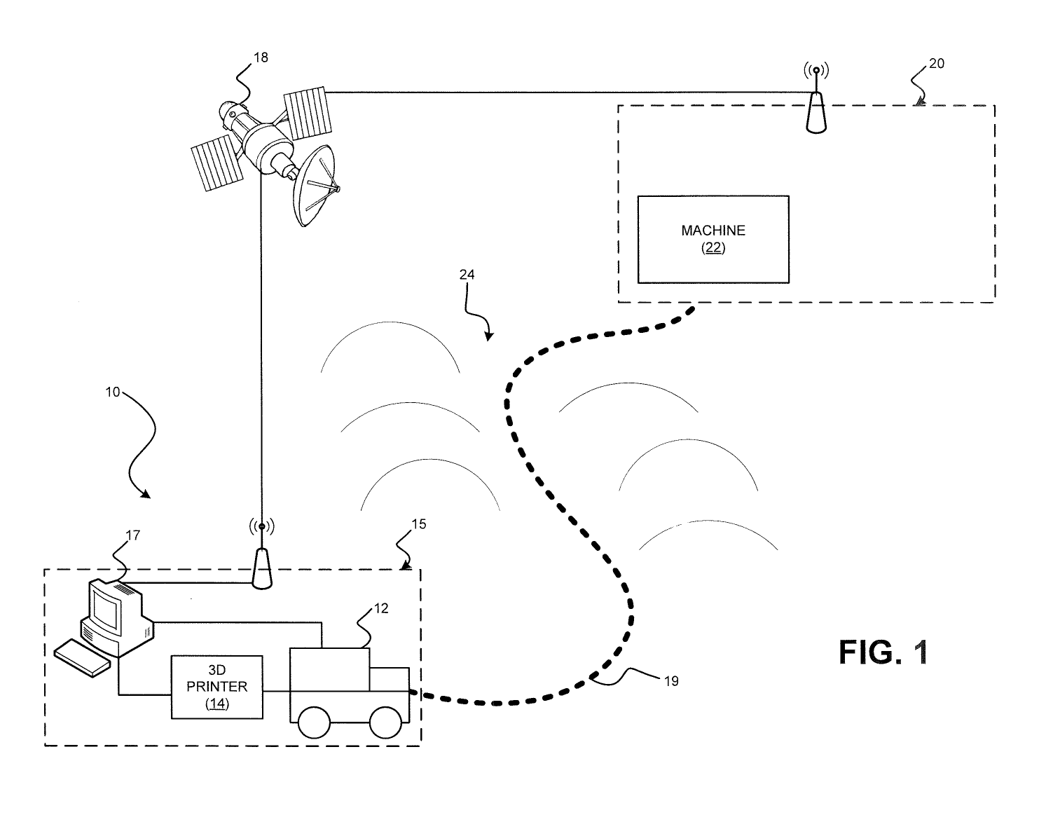

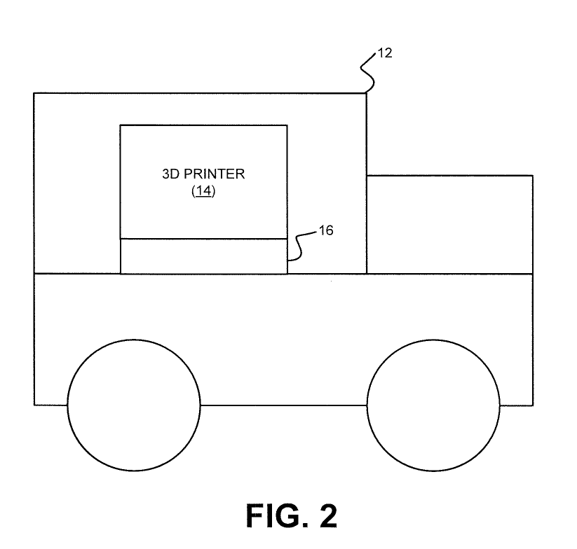

Turning now to the drawings and with specific reference to FIG. 1, a system 10 for mobile 3-D printing is shown. The system includes a transport 12 and a 3-D printer 14, which is associated with the transport 12, at a dealer site 15. The 3-D printer 14 travels with the transport 12. While the 3-D printer may be contained within the transport 12, it is not limited to being contained within the transport 12 and may travel with the transport 12 via other connections (e.g., the 3-D printer 14 may be contained in a trailer hitched or otherwise connected to the transport 12). However, as shown in the example configuration of FIG. 2, the 3-D printer 14 may be contained within the transport 12 and may be mounted to a surface of the transport 12 using a mount 16. The mount may be, for example, an iso-mount system.

Although in FIGS. 1 and 2 the transport 12 is depicted, generally, as a service truck, the transport 12 is not limited to being a service truck and may be any suitable transportation vehicle that may move a machine component from one site to another site. For example, the transport 12 may be, but is not limited to being, a truck, an automobile, a train, an aircraft, a helicopter, etc.

The 3-D printer 14 may be any apparatus suitable for 3-D printing, which may also be referred to as “additive manufacturing.” 3-D printing is defined herein as any process for printing a three-dimensional object wherein successive layers of material are laid down under computer control. The 3-D printer 14 may print a nearly limitless variety of components for a nearly limitless variety of machines having almost any shape or geometry based on a 3-D model. The 3-D model may be provided locally by a computer associated with the 3-D printer 14 or may be provided remotely from a computer in a remote location.

A variety of processes which may be employed by the 3-D printer 14 to print a machine component are well known in the art and may include, but are not limited to including, granular processes (e.g., direct metal laser sintering, electron-beam melting, selective laser melting, selective heat sintering, selective laser sintering, etc.), wire processes (e.g., electron beam freeform fabrication, etc.), powder bed and/or inkjet head 3-D printing processes (e.g., plaster-based 3-D printing, etc.), laminated processes (e.g., plaster-based 3-D, etc.), light polymerized processes (e.g., stereolithography, digital light processing, etc.), and the like. Further, the 3-D printer 14 may form components for machines out of any suitable material for a respective printer process, such as, but not limited to, thermoplastics, thermoplastic powder, high-density polyethylene, eutectic metals, rubber, modeling clay, plasticine, silicone, porcelain, metal clay, metal alloys, stainless steel, aluminum, metal powders, ceramic powders, plaster, paper, metal foil, plastic film, photopolymers, and the like. The specific process and material used by the 3-D printer 14 is based on the specifications desired for the component to be printed. The 3-D printer 14 may select a printing process and/or speed based on conditions associated with the system 10, which will be discussed in more detail below.

The transport 12 may receive instructions from and provide information to a computer 17. The computer 17 may calculate distances and routes to/from one or more customer sites based on information provided by a positioning system 18. The positioning system 18 may be any location based system for providing information associated with one or more locations. Using information provided by the positioning system 18, the computer 17 may determine a route 19 between the transport 12 and a customer site 20.

In the present example, a satellite based global positioning system (GPS) is shown; however, the positioning system 18 is not limited to being a GPS system. The positioning system 18 may be any system that provides position and/or location information to the dealer and/or customer for the purposes of determining the route 19 between the dealer location 15 and the customer site 20. Examples of other positioning systems that can be used to implement the positioning system 18 may include, but are not limited to including, mapping systems, computer and/or internet based maps (e.g., Google Maps, Bing Maps, Apple Maps, etc.), customer location databases, and the like.

At the customer site 20, a machine 22 may need a machine component as a replacement part. A customer at the customer site 20 may request the machine component from the dealer at the dealer site 15. The dealer may use the computer 17 to determine a distance between the transport 12 and the customer site 20 based on positioning information received from the positioning system 18. Using the computer 17 and utilizing the position information, the route 19 is determined. Positioning information from the positioning system 18 may also be used to determine a terrain 24 along the route 19. The computer 17 may determine an optimal print rate for the 3-D printer 14 based on the terrain 24 and/or the route 19. Additionally or alternatively, the computer 17 may determine an optimal printing process for the 3-D printer based on the terrain 24 and/or the route 19.

The 3-D printer 14 travels with the transport 12 along the route 19 to the customer site 20. While travelling along the route 19, the 3-D printer 14 will print the desired component for the machine 22. In some examples, the 3-D printer 14 will be configured to print the component for the machine 22 such that the printing is completed before the transport 12 arrives at the customer site 20. In some alternative examples, the 3-D printer may begin printing the component for the machine 22 during the travel along the route 19 and subsequently finish printing while stopped at the customer site 20.

While the computer 17 is shown at the dealer site 15, the computer does not need to be at the dealer site 15 and may communicate with other elements of the system 10 by any wired or wireless mode of communication. Further, the computer 17 may represent one or more computers working in association to receive information and/or provide instructions to various elements of the system 10.

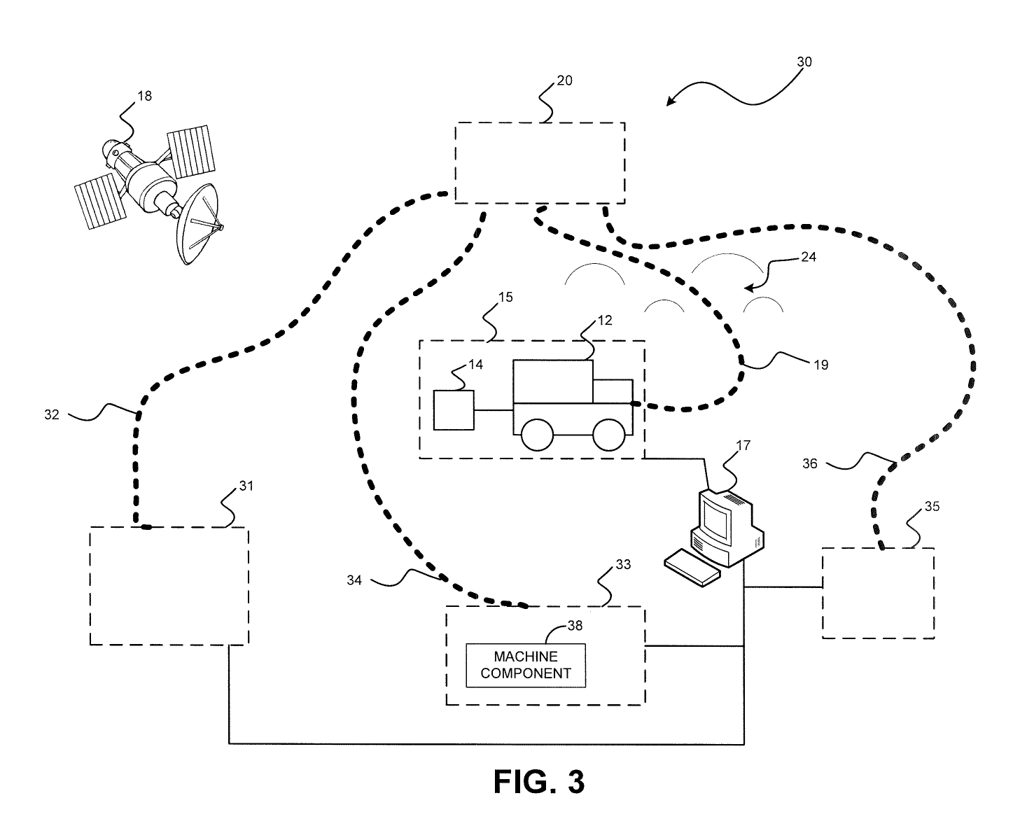

Turning now to FIG. 3, a map 30 is shown, implementing the system 10 in a scenario wherein the customer may receive the component of the machine 22 from the dealer site 15 or one of a plurality of part storage facilities 31, 33, 35. The storage facilities 31, 33, 35 may have a previously manufactured component in stock which can be used as the component for the machine 22. The computer 17 may receive positioning signals from the positioning system 18, the positioning signals associated with one or more of the part storage facilities 31, 33, 35 and for determining a location of each part storage facilities 31, 33, 35. Using the positioning signals, the computer 17 may determine transportation routes 32, 34, 36 between the part storage facilities 31, 33, 35, respectively, and the customer site 20. As mentioned above, the computer 17 also uses positioning signals from the positioning system 18 to determine the route 19 between the transport 12 and the customer location 20.

The computer 17 may determine if any of the part storage facilities 31, 33, 35 have a machine component in stock which may be used as the desired component for the machine 22. For example, the computer 17 may access a world-wide inventory system/network which has information regarding the stock of components at various dealer sites and storage facilities. In the present example, dealer storage site 33 has a machine component 38 in stock, which is acceptable for use as the desired machine component for the machine 22. However, any of the part storage facilities 31, 33, and 35 are capable of having a machine component in stock. If the computer 17 determines that the machine component 38 is available at storage facility 33, then it will determine the transportation route 34 between the storage facility 33 and the customer site 20.

With routes 19 and 34 determined, the computer 17 may then determine whether to have the machine component 38 shipped to the customer site 20 from the storage facility 33 or to 3-D print a component for the machine 22 using the 3-D printer 14 while the 3-D printer 14 travels with the transport 12 when travelling from the dealer site 15 to the customer site 20. The computer 17 may use a variety of factors in determining whether to have the machine component 38 shipped or to have a component 3-D printed, such as cost and time. In an example embodiment, the computer 17 may determine which of the routes 19 and 34 will deliver a replacement component to the customer site 20 in the shortest amount of time. If travel along route 19 will deliver a replacement component to the customer fastest, then the 3-D printer 14 will print a replacement component while travelling with the transport 12 along the route 19. However, if travel along the route 34 will deliver the component part 38 to the customer fastest, then the component part 38 may be delivered from the part storage facility 33 to the customer site 20. Determining which route is faster is not limited to only distance, but such determinations may include consideration of any other factors such as transport vehicle speeds, terrain, weather, traffic, delivery personnel availability, etc.

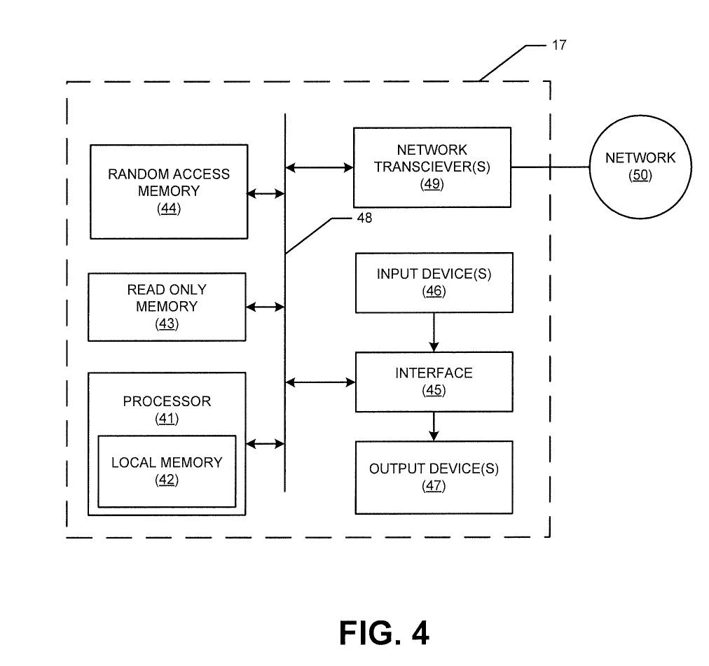

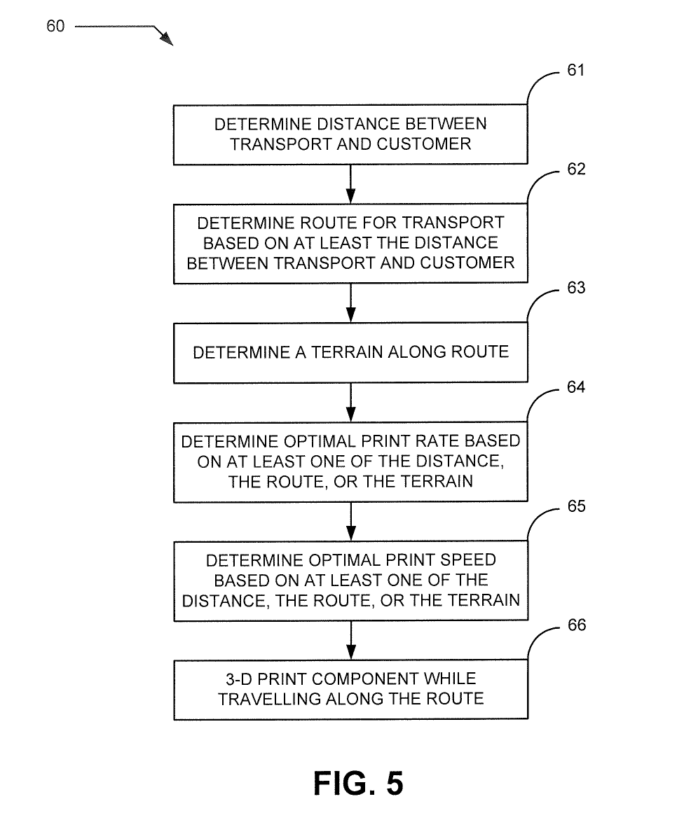

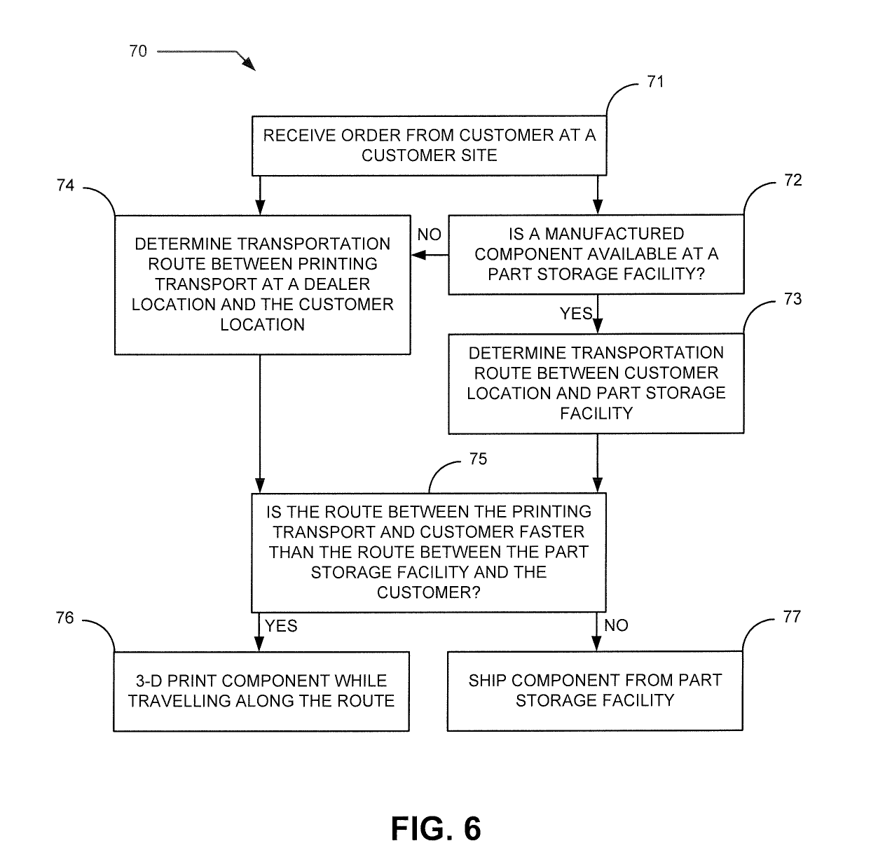

A combination of hardware and software may be used to implement instructions in association with the computer 17 of the system 10 as shown in FIGS. 1 and 3. FIG. 4 is a block diagram of an example computer 17 capable of executing instructions to realize the functions of the system 10 and/or execute instructions to perform the methods discussed below in reference to FIGS. 5-6. The computer 17 may be, for example, a server, a personal computer, or any other type of computing device. The computer 17 of the instant example includes a processor 41. For example, the processor 41 may be implemented by one or more microprocessors or controllers from any desired family or manufacturer.

The processor 41 includes a local memory 42 and is in communication with a main memory including a read only memory 43 and a random access memory 44 via a bus 48. The random access memory 44 may be implemented by Synchronous Dynamic Random Access Memory (SDRAM), Dynamic Random Access Memory (DRAM), RAMBUS Dynamic Random Access Memory (RDRAM) and/or any other type of random access memory device. The read only memory 43 may be implemented by a hard drive, flash memory and/or any other desired type of memory device.

The computer 17 may also include an interface circuit 45. The interface circuit 45 may be implemented by any type of interface standard, such as, for example, an Ethernet interface, a universal serial bus (USB), and/or a PCI express interface. One or more input devices 46 are connected to the interface circuit 45. The input device(s) 46 permit a user to enter data and commands into the processor 41. The input device(s) 46 can be implemented by, for example, a keyboard, a mouse, a touchscreen, a track-pad, a trackball, and/or a voice recognition system. For example, the input device(s) 46 may include any wired or wireless device for connecting the computer 17 to the positioning system 18 to receive positioning signals.

One or more output devices 47 are also connected to the interface circuit 45. The output devices 47 can be implemented by, for example, display devices for associated data (e.g., a liquid crystal display, a cathode ray tube display (CRT), etc.).

Further, the computer 17 may include one or more network transceivers 49 for connecting to a network 50, such as the Internet, a WLAN, a LAN, a personal network, or any other network for connecting the computer 17 to one or more other computers or network capable devices. As such, the computer 17 may be embodied by a plurality of computers 17 for controlling various elements of the system 10, such as a computer associated with and providing instructions to the 3-D printer 14, a computer associated with and providing instructions to the transport 12, a computer associated with the positioning system and transmitting positioning signals, and any additional computers associated with one or more of the customer site 20, the dealer site 15, and the part storage facilities 31, 33, 35.

As mentioned above the computer 17 may be used to execute machine readable instructions. For example, the computer 17 may execute machine readable instructions to perform the methods shown in the block diagrams of FIGS. 5-6 and described in more detail below. In such examples, the machine readable instructions comprise a program for execution by a processor such as the processor 41 shown in the example computer 17. The program may be embodied in software stored on a tangible computer readable medium such as a CD-ROM, a floppy disk, a hard drive, a digital versatile disk (DVD), a Blu-ray disk, or a memory associated with the processor 17, but the entire program and/or parts thereof could alternatively be executed by a device other than the processor 17 and/or embodied in firmware or dedicated hardware. Further, although the example programs are described with reference to the flowcharts illustrated in FIGS. 5-6, many other methods of implementing embodiments of the present disclosure may alternatively be used. For example, the order of execution of the blocks may be changed, and/or some of the blocks described may be changed, eliminated, or combined.

Turning now to FIG. 5, and with continued reference to FIG. 1, a flowchart for an example method 60 for mobile 3-D printing of a component of the machine 22 is shown. The method 60 includes determining a distance between the transport 12 and the customer site 20 based on, at least, positioning information provided by the positioning system 18 (block 61). A route 19 is determined for the transport 12 based on, at least, the distance between the transport 12 and the customer site 20 (block 62). In some examples, the method 60 may include determining a terrain 24 along the route 19 (block 63). In some such examples, the method may include determining an optimal print rate based on at least one of the distance between the customer site 20 and the transport 12, the route 19, or the terrain 24 (block 64). Additionally or alternatively, the method may include determining an optimal print speed based on at least one of the distance between the customer site 20 and the transport 12, the route 18, or the terrain 24 (block 65).

The 3-D printer 14 associated with the transport 12 will then 3-D print the component part of the machine 22 while the transport 12 travels along the route 18 to the customer site 20, wherein the 3-D printer 14 travels with the transport 12 (block 66). In some examples, the 3-D printing of the component of the machine 20 may include beginning printing while travelling along the route 19 and finishing printing while at the customer site 20.

FIG. 6 shows a flowchart for a method for providing a component of the machine 22 to a customer by optionally utilizing 3-D printing of the component. The dealer receives an order from a customer, the customer being at a customer site 20 (block 71). The dealer will determine if a manufactured machine component 38 is available at a part storage facility 33 (block 72). If the machine component 38 is available at the part storage facility, then the dealer will determine a transportation route 34 between the customer location and the part storage facility 33 (block 73). Additionally, the dealer will determine a route 19 between a transport 12, which travels with an associated 3-D printer 14, and the customer site 20 (block 74). Then, the dealer will determine which of the routes 19 and 34 will get the component, either printed or manufactured, to the customer site 20 fastest (block 75). If the route 19 is fastest, then the transport 12 will 3-D print the component while travelling from the dealer location 15 to the customer site 20 (block 76). Otherwise, if the route 33 is fastest, then the dealer will ship the machine component 38 from the part storage facility 33 to the customer site 20.

### Industrial Applicability

The present disclosure generally relates to providing, by a dealer, machine parts to a customer and, more particularly, relates to systems and methods for mobile three-dimensional (3-D) printing of machine components. By utilizing the system 10 to employ the methods 50 and 60, the embodiments of the present disclosure may be used to improve upon shipping time for machine components from a dealer to a customer. On the customers end, the systems and methods are beneficial because they may reduce the wait time for a new component upon placing an order with a dealer. Also such systems and methods may reduce the costs of shipping, which, in some customer-dealer interactions, are passed down to the consumer. Further, on the dealer's end, the systems and methods of the present disclosure may provide for cost savings. Cost savings may arise from 3-D printing because full scale manufacture of rarely used parts will be unnecessary. Also, reduction in shipping times and distances may lead to reduced fuel costs for the dealers shipping their products and/or mobile 3-D printing said products. A reduction in cost and wait time for the consumer may also benefit the dealer because a pleased consumer may result in a positive effect on the dealer's reputation in its respective commercial market.

It will be appreciated that the present disclosure provides and systems and methods for mobile 3-D printing of machine components. While only certain embodiments have been set forth, alternatives and modifications will be apparent from the above description to those skilled in the art. These and other alternatives are considered equivalents and within the spirit and scope of this disclosure and the appended claims.

What is claimed is:

1. A method for mobile three-dimensional (3-D) printing of a component of a machine, the method comprising:
determining a distance between a transport and a customer based on, at least, positioning information provided by a positioning system;
determining a route for the transport to travel to the customer based on, at least, the distance between the transport and the customer;
printing, at least in part, the component of the machine using a 3-D printer while the transport travels along the route, the 3-D printer being associated with the transport and travelling with the transport along the route.

2. The method of claim 1, further comprising determining a terrain of a location on the route for the transport to travel to the customer.

3. The method of claim 2, further comprising determining an optimal print rate for the 3-D printer based on, at least, the terrain.

4. The method of claim 2, further comprising determining an optimal printer process for the 3-D printer based on, at least, the terrain.

5. The method of claim 1, further comprising determining an optimal print rate for the 3-D printer based on, at least, the route.

6. The method of claim 1, further comprising determining an optimal printer process for the 3-D printer based on, at least, the route.

7. The method of claim 1, wherein printing the component of the machine using the 3-D printer includes:
beginning printing when the transport leaves a first location; and
finishing printing when the transport arrives at the customer.

8. A system for mobile three-dimensional (3-D) printing of a component of a machine, the system comprising:
a transport for delivering the component to a customer;
a positioning system for providing positioning information associated with a location of the customer;
a controller configured to:
receive the positioning information from the positioning system;
determine a distance between the transport and the customer using the position signals; and
determine a route for the transport to travel to the customer; and
a 3-D printer associated with the transport, configured to travel with the transport along the route, and configured to print the component while travelling along the route.

9. The system of claim 8, wherein the controller is further configured to:
determine a terrain of a location on the route for the transport to travel to the customer;
determine an optimal print rate for the 3-D printer based on, at least one of the terrain and the route.

10. The system of claim 8, wherein the controller is further configured to:
determine a terrain of a location on the route for the transport to travel to the customer;
determine an optimal printer process for the 3-D printer based on, at least one of the terrain and the route.

11. The system of claim 8, wherein the positioning system is a global positioning system (GPS).

12. The system of claim 9, wherein the transport is a service truck associated with a dealer of the machine.

13. The system of claim 12, wherein the 3-D printer is affixed to the interior of the service truck.

14. The system of claim 13, wherein the 3-D printer is affixed to the interior of the service truck using an iso-mount system.

15. A method for providing a component of a machine to a customer by optionally utilizing three-dimensional (3-D) printing of the component, the method comprising:
receiving an order for the component from the customer, the customer at a customer location;
determining availability of a manufactured component at a part storage location;
determining a first transportation route if the manufactured component is available at the part storage location, the first transportation route being between the customer location and the part storage location;
determining a second transportation route, the second transportation route being between the customer location and a printing transport, the printing transport being associated with a 3-D printer and capable of travelling with the 3-D printer, the 3-D printer capable of printing a printed component for use as the component;
determining if the printing transport travelling along the second route will arrive at the customer location at an earlier time than a transport travelling along the first route;
printing, at least in part, the printed component using the 3-D printer while the printing transport travels along the second route if the printing transport travelling along the second route will arrive at the customer location at an earlier time than the transport travelling along the first route.

16. The method of claim 15, further comprising delivering the manufactured component from the part storage location using the transport travelling along the first route if the transport travelling along the first route will arrive at the customer location at an earlier time than the printing transport travelling along the second route.

17. The method of claim 15, wherein determining the second route includes determining a terrain along the second route.

18. The method of claim 17, wherein printing, at least in part, the printed component using the 3-D printer while the printing transport travels along the second route includes optimizing the print rate based on at least one of the route and the terrain.

19. The method of claim 17, wherein printing, at least in part, the printed component using the 3-D printer while the printing transport travels along the second route includes determining an optimal printing process based on at least one of the route and the terrain.

20. The method of claim 15, wherein printing the printed component using the 3-D printer includes:
beginning printing when the printing transport leaves a first location; and
finishing printing when the printing transport arrives at the customer.
